(19) United States
(12) Patent Application Publication
(10) Pub. No.: US 2025/0011221 A1
(43) Pub. Date: Jan. 9, 2025

(54) GLASS, GLASS ELEMENT AND OPTICAL FILTER

(71) Applicant: CDGM GLASS CO., LTD, Chengdu (CN)

(72) Inventor: Wei SUN, Chengdu (CN)

(73) Assignee: CDGM GLASS CO., LTD, Chengdu (CN)

(21) Appl. No.: 18/888,613

(22) Filed: Sep. 18, 2024

Related U.S. Application Data
(63) Continuation of application No. PCT/CN2023/077372, filed on Feb. 21, 2023.

(30) Foreign Application Priority Data
Mar. 24, 2022 (CN) 202210294645.5

(51) Int. Cl. C03C 3/247; C03C 3/062; C03C 3/068; C03C 4/02; C03C 4/08; G02B 5/20

(52) U.S. Cl. CPC C03C 3/247; C03C 3/062; C03C 3/068; C03C 4/02; C03C 4/082; C03C 2204/00; G02B 5/208

(57) ABSTRACT

A glass includes following components in molar percentage of cations: P⁵⁺: 51-72%; Al³⁺: 0-10%; Cu²⁺: 5-25%; Rn⁺: 5-25%; R²⁺: 1-18%; Ln³⁺: 0-8%, wherein Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺; the glass also includes the following components of anions: O²⁻ and F⁻, and a total content of O²⁻ and F⁻ (O²⁻+F⁻) is more than 98%. Through reasonable component design, the glass obtained by the present application has excellent intrinsic quality, excellent transmission properties in the visible range, and excellent absorption properties in the near-infrared region.

### CROSS-REFERENCE TO RELATED APPLICATIONS

The present application is a continuation application of International Application No. PCT/CN2023/077372, filed on Feb. 21, 2023, which claims priority to Chinese patent application No. 202210294645.5, and filed on Mar. 24, 2022. The disclosures of the above-mentioned applications are incorporated herein by reference in their entireties.

### TECHNICAL FIELD

The present application relates to the technical field of glass, and in particular to a near-infrared light absorbing glass.

### BACKGROUND

In recent years, the spectral sensitivity of semiconductor imaging elements such as CCD, CMOS used in digital cameras, camera phones, and VTR cameras, has spread from the visible range to the near-infrared range; using an optical filter that absorbs light in the near-infrared range can achieve a sensitivity similar to that of human vision. The visible light wavelength range perceptible to the human eye is between 400 and 700 nm. Therefore, by using an optical filter that absorbs near-infrared light, it is possible to obtain images with brightness factors similar to those perceived by human eyes. As the demand for color sensitivity correction filters continues to grow, there is a corresponding increase in the requirements for near-infrared light absorbing glass used in the production of such filters. This glass is required to have excellent transmission properties in the visible range, and excellent absorption properties in the near-infrared range. The near-infrared light absorbing glass in the prior art usually includes a large amount of fluorine (F⁻), such as Chinese patent CN102656125A. When it includes a large amount of fluorine, the fluorine will volatilize during the glass melting process, causing the glass to easily have defects such as streaks and internal unevenness, and it is difficult for the internal quality of the glass to meet the requirements.

### SUMMARY

Based on the above reasons, the technical problem addressed by the present application is to provide a glass with excellent intrinsic quality, excellent transmittance properties in the visible range and excellent absorption properties in the near-infrared range.

The technical solution proposed by the present application to address the problem is as follows.
(1) A glass includes following components in molar percentage of cations: P⁵⁺: 51-72%; Al³⁺: 0-10%; Cu²⁺: 5-25%; Rn⁺: 5-25%; R²⁺: 1-18%; Ln³⁺: 0-8%, Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺; and
the glass includes the following components of anions: O²⁻ and F⁻, with a total content of O²⁻ and F⁻ (O²⁻+F⁻) being more than 98%.
(2) The glass according to (1), further includes the following components in molar percentage of cations: Zn²⁺: 0-10%; and/or Si⁴⁺: 0-5%; and/or B³⁺: 0-5%; and/or Zr⁴⁺: 0-5%; and/or Sb³⁺+Sn⁴⁺+Ce⁴⁺: 0-1%.
(3) A glass includes following components in molar percentage of cations: P⁵⁺: 51-72%; Al³⁺: 0-10%; Cu²⁺: 5-25%; Rn⁺: 5-25%; R²⁺: 1-18%; Ln³⁺: 0-8%; Zn²⁺: 0-10%; Si⁴⁺: 0-5%; B³⁺: 0-5%; Zr⁴⁺: 0-5%; Sb³⁺+Sn⁴⁺+Ce⁴⁺: 0-1%, Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺; and the glass includes the following components of anions: O²⁻ and F⁻.
(4) The glass according to any of (1) to (3), the components in molar percentage of the glass include: Al³⁺/Ln³⁺ is greater than 0.2, preferably Al³⁺/Ln³⁺ is 0.2-20.0, more preferably Al³⁺/Ln³⁺ is 0.5-15.0, further preferably Al³⁺/Ln³⁺ is 1.0-10.0, and still further preferably Al³⁺/Ln³⁺ is 1.5-8.0.
(5) The glass according to any of (1) to (4), the components in molar percentage of the glass include: Li⁺/(Mg²⁺+Al³⁺) is 0.4-10.0, preferably Li⁺/(Mg²⁺+Al³⁺) is 0.6-7.0, more preferably Li⁺/(Mg²⁺+Al³⁺) is 1.0-5.0, and further preferably Li⁺/(Mg²⁺+Al³⁺) is 1.2-3.0.
(6) The glass according to any of (1) to (5), the components in molar percentage of the glass include: Cu²⁺/Al³⁺ is 1.0-15.0, preferably Cu²⁺/Al³⁺ is 2.0-10.0, more preferably Cu²⁺/Al³⁺ is 3.0-8.0, and further preferably Cu²⁺/Al³⁺ is 4.0-7.0.
(7) The glass according to any of (1) to (6), the components in molar percentage of the glass include: (Cu²⁺+Mg²⁺)/(Li⁺+Al³⁺) is 0.3-6.0, preferably (Cu²⁺+Mg²⁺)/(Li⁺+Al³⁺) is 0.5-5.0, more preferably (Cu²⁺+Mg²⁺)/(Li⁺+Al³⁺) is 0.7-3.0, and further preferably (Cu²⁺+Mg²⁺)/(Li⁺+Al³⁺) is 0.8-2.0.
(8) The glass according to any of (1) to (7), the components in molar percentage of the glass include: Ln³⁺/R²⁺ is greater than 0.01, preferably Ln³⁺/R²⁺ is 0.01-3.0, more preferably Ln³⁺/R²⁺ is 0.03-1.0, further preferably Ln³⁺/R²⁺ is 0.05-0.8, and still further preferably Ln³⁺/Rn²⁺ is 0.07-0.5.
(9) The glass according to any of (1) to (8), the components in molar percentage of the glass include: Ln³⁺/(Ba²⁺+Al³⁺) is greater than 0.02, preferably Ln³⁺/(Ba²⁺+Al³⁺) is 0.02-2.0, more preferably Ln³⁺/(Ba²⁺+Al³⁺) is 0.05-1.0, further preferably Ln³⁺/(Ba²⁺+Al³⁺) is 0.08-0.8, and still further preferably Ln³⁺/(Ba²⁺+Al³⁺) is 0.1-0.5.
(10) The glass according to any of (1) to (9), the components in molar percentage of the glass include: P⁵⁺/(Al³⁺+Ln³⁺) is 5.0-50.0, preferably P⁵⁺/(Al³⁺+Ln³⁺) is 10.0-35.0, more preferably P⁵⁺/(Al³⁺+Ln³⁺) is 12.0-30.0, and further preferably P⁵⁺/(Al³⁺+Ln³⁺) is 15.0-25.0.
(11) The glass according to any of (1) to (10), the components in molar percentage of the glass include: Cu²⁺/Ln³⁺ is greater than 2.0, preferably Cu²⁺/Ln³⁺ is 2.0-40.0, more preferably Cu²⁺/Ln³⁺ is 5.0-30.0, further preferably Cu²⁺/Ln³⁺ is 8.0-20.0, and still further preferably Cu²⁺/Ln³⁺ is 10.0-15.0.
(12) The glass according to any of (1) to (11), the components in molar percentage of the glass include: P⁵⁺/R²⁺ is 3.0-30.0, preferably P⁵⁺/R²⁺ is 3.5-25.0, more preferably P⁵⁺/R²⁺ is 4.0-20.0, and further preferably P⁵⁺/R²⁺ is 5.0-10.0.
(13) The glass according to any of (1) to (12), the components in molar percentage of the glass include: Ln³⁺/F⁻ is greater than 0.01, preferably Ln³⁺/F⁻ is 0.02-10.0, more preferably Ln³⁺/F⁻ is 0.05-5.0, further preferably Ln³⁺/F⁻ is 0.05-2.0, and still further preferably Ln³⁺/F⁻ is 0.1-1.0.
(14) The glass according to any of (1) to (13), the components in molar percentage of the glass include: F⁻/Cu²⁺ is 0.05-2.0, preferably F⁻/Cu²⁺ is 0.1-1.5, more preferably F⁻/Cu²⁺ is 0.2-1.0, and further preferably F⁻/Cu²⁺ is 0.3-0.8.
(15) The glass according to any one of (1) to (14), the components in molar percentage of the glass include: P⁵⁺: 56-68%, preferably P⁵⁺: 60-65%; and/or Al³⁺: 0.5-8%, preferably Al³⁺: 1-5%; and/or Cu²⁺: 6-20%, preferably Cu²⁺: 8-15%; and/or Rn⁺: 7-20%, preferably Rn⁺: 10-17%; and/or R²⁺: 3-16%, preferably R²⁺: 5-14%; and/or Ln³⁺: 0.1-6%, preferably Ln³⁺: 0.5-4%; and/or Zn²⁺: 0-5%, preferably Zn²⁺: 0-2%; and/or Si⁴⁺: 0-2%, preferably Si⁴⁺: 0-1%; and/or B³⁺: 0-2%, preferably B³⁺: 0-1%; and/or Zr⁴⁺: 0-2%, preferably Zr⁴⁺: 0-1%; and/or Sb³⁺+Sn⁴⁺+Ce⁴⁺: 0-0.5%, preferably Sb³⁺+Sn⁴⁺+Ce⁴⁺: 0-0.1%, wherein Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺.
(16) The glass according to any one of (1) to (15), the components in molar percentage of the glass include: Li⁺: 5-25%, preferably Li⁺: 8-20%, more preferably Li⁺: 10-16%; and/or Na⁺: 0-10%, preferably Na⁺: 0-5%, more preferably Na⁺: 0-2%; and/or K⁺: 0-10%, preferably K⁺: 0-5%, more preferably K⁺: 0-2%; and/or Mg²⁺: 0-15%, preferably Mg²⁺: 0.5-10%, more preferably Mg²⁺: 2-8%; and/or Ca²⁺: 0-10%, preferably Ca²⁺: 0-5%, more preferably Ca²⁺: 0-2%; and/or Sr²⁺: 0-10%, preferably Sr²⁺: 0-5%, more preferably Sr²⁺: 0-2%; and/or Ba²⁺: 0-10%, preferably Ba²⁺: 0.5-8%, more preferably Ba²⁺: 1-6%; and/or La³⁺: 0-5%, preferably La³⁺: 0-3%, more preferably La³⁺: 0-2%; and/or Gd³⁺: 0-5%, preferably Gd³⁺: 0-3%, more preferably Gd³⁺: 0-2%; and/or Y³⁺: 0-6%, preferably Y³⁺: 0.1-5%, more preferably Y³⁺: 0.5-3%.
(17) The glass according to (1) or (2), further includes the following components in molar percentage of anions: Cl⁻+Br⁻+I⁻: 0-2%, preferably Cl⁻+Br⁻+I⁻: 0-1%, and more preferably Cl⁻+Br⁻+I⁻: 0-0.5%.
(18) The glass according to any one of (1) to (17), further includes the following components in molar percentage of anions: O²⁻: 85-99.5%, preferably O²⁻: 88-99%, and more preferably O²⁻: 91-98%; and/or F⁻: 0.5-15%, preferably F⁻: 1-12%, and more preferably F⁻: 2-9%.
(19) The glass according to any one of (1) to (18), a transition temperature T_{g} of the glass is less than 410° C., preferably less than 400° C., more preferably less than 390° C., and further preferably 370-390° C.; and/or the density ρ is less than 3.3 g/cm³, preferably less than 3.2 g/cm³, more preferably less than 3.1 g/cm³, and further preferably less than 3.0 g/cm³; and/or the coefficient of thermal expansion α_{20-120° C.} is less than 110×10⁻⁷/K, preferably less than 100×10⁻⁷/K, and more preferably less than 95×10⁻⁷/K; and/or the hardness Hᵥ is more than 380 kgf/mm², preferably more than 390 kgf/mm², more preferably more than 400 kgf/mm², and further preferably more than 410 kgf/mm²; Young's modulus E is 5500×10⁷-8500×10⁷ Pa, preferably 6000×10⁷-8000×10⁷ Pa, and more preferably 6500×10⁷-7500×10⁷ Pa.
(20) The glass according to any one of (1) to (19), for glass with a thickness of less than 0.5 mm, in a spectral transmittance within a wavelength range of 500-700 nm, a wavelength λ₅₀ corresponding to the transmittance being 50% is less than 635 nm, preferably 600-630 nm, more preferably 610-625 nm.
(21) The glass according to any one of (1) to (20), for the glass with a thickness of less than 0.5 mm, the transmittance τ₄₀₀ at 400 nm is more than 80.0%, preferably more than 82.0%, and more preferably more than 84.0%; and/or the transmittance τ₅₀₀ at 500 nm is more than 83.0%, preferably more than 85.0%, and more preferably more than 88.0%; and/or the transmittance τ₁₁₀₀ at 1100 nm is less than 10.0%, preferably less than 7.0%, more preferably less than 5.0%, and further preferably less than 3.0%.
(22) The glass according to (20) or (21), the thickness of the glass is 0.05 to 0.4 mm, preferably 0.1 to 0.3 mm, and more preferably 0.1 mm, 0.15 mm, 0.2 mm, or 0.25 mm.
(23) A glass element includes the glass according to any one of (1) to (21).
(24) An optical filter includes the glass according to any one of (1) to (21), or includes the glass element according to (23).
(25) A device includes the glass according to any one of (1) to (21), or includes the glass element according to (23), or includes the optical filter according to (24).

The beneficial effect of the present application is that through reasonable component design, the glass obtained by the present application has excellent intrinsic quality, excellent transmittance characteristics in the visible range and excellent absorption characteristics in the near-infrared region.

### DETAILED DESCRIPTION OF THE EMBODIMENTS

The following is a detailed description of the embodiments of the present application. However, the present application is not limited to the following embodiments, and may be implemented with appropriate modifications within the scope of the objectives of the present application. Additionally, regarding the repeated descriptions, although there may be appropriate omissions, this will not limit the essence of the application.

### <Glass>

The following is a description of the range of each component (ingredient) constituting the glass of the present application. In this specification, unless otherwise specified, the content of the cationic component is expressed as the molar percentage (mol %) of the cation in all cationic components, and the content of the anionic component is expressed as the molar percentage (mol %) of the anion in all anionic components; the ratio between the contents of the cationic components is the ratio of the molar percentage of the contents of the various cationic components; the ratio between the contents of the anionic components is the ratio of the molar percentage of the contents of the various anionic components; the ratio between the contents of the anionic and cationic components is the ratio between the molar percentage of the cationic component in all cationic components and the molar percentage of the anionic component in all anionic components.

Unless otherwise specified in specific circumstances, the numerical ranges listed herein include upper and lower limits, “above (more than, greater than)” and “below (less than)” include endpoint values, and all integers and fractions included in the range, without limitation to the specific values listed when the range is defined. “And/or” as referred to herein is inclusive, for example, “A and/or B” means only A, or only B, or both A and B.

It should be noted that the ionic valence of each component described below is a representative value used for convenience and is no different from other ionic valences. There is a possibility that the ionic valence of each component in the glass may differ from the representative value. For example, P usually exists in the glass in a state of ionic valence of +5, so “P⁵⁺” is used as a representative value in the present application, but there is a possibility of existing in other ionic valence states, which is also within the scope of protection of the present application.

### <Cationic Component>

P⁵⁺ is an indispensable component of the glass skeleton of the present application, which can promote the formation of glass and improve the near-infrared absorption performance of glass. If the content of P⁵⁺ is less than 51%, the above effects are insufficient, and the near-infrared absorption function of glass cannot meet the design requirement; if the content of P⁵⁺ exceeds 72%, the glass exhibits an increased tendency toward devitrification, and its weather resistance decreases. Therefore, the content of P⁵⁺ in the present application is 51-72%, with a preferred range of 56-68%, and a more preferred range of 60-65%. In some embodiments, the content of P⁵⁺ may be approximately 51%, 52%, 53%, 54%, 55%, 56%, 57%, 58%, 59% 60%, 61%, 62%, 63%, 64%, 65%, 66%, 67%, 68%, 69%, 70%, 71%, or 72%.

Al³⁺ is beneficial to increase the stability of glass, improve the strength of glass and improve the weather resistance of glass, but when its content exceeds 10%, the crystallization tendency of glass increases and the melting performance of glass deteriorates. Therefore, the content of Al³⁺ in the present application is 0-10%, with a preferred range of 0.5-8%, and a more preferred range of 1-5%. In some embodiments, the content of Al³⁺ may be approximately 0, greater than 0, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%.

Cu²⁺ is a necessary component for the glass of the present application to obtain near-infrared light absorption performance. If its content is less than 5%, the near-infrared absorption performance of the glass is difficult to meet the design requirements. However, if the content of Cu²⁺ exceeds 25%, the transmittance of the glass in the visible light range decreases, the valence state of Cu in the glass changes, it is difficult to obtain the desired light absorption performance, and the devitrification resistance of the glass decreases. Therefore, the content of Cu²⁺ in the present application is 5-25%, with a preferred range of 6-20%, and a more preferred range of 8-15%. In some embodiments, the content of Cu²⁺ may be approximately 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, or 25%.

In some embodiments, the ratio of the content of Cu²⁺ to Al³⁺, Cu²⁺/Al³⁺, is controlled within the range of 1.0 to 15.0, so that the glass has excellent transmittance in the visible light range, improved near-infrared absorption performance, and a suitable Young's modulus. Therefore, Cu²⁺/Al³⁺ of 1.0-15.0 is preferred, with a more preferred range of 2.0-10.0, an even more preferred range of 3.0-8.0, and further preferably 4.0-7.0. In some embodiments, the value of Cu²⁺/Al³⁺ may be 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, or 15.0.

Ln³⁺ (Ln³⁺ is one or more of La³⁺, Gd³⁺, and Y³⁺) is beneficial to improving the visible light transmittance and near-infrared absorption performance of the glass, and improving the chemical stability and hardness of the glass. If its content exceeds 8%, the glass's resistance to crystallization decreases. Therefore, the content of Ln³⁺ is less than 8%, preferably 0.1⁻⁶%, and more preferably 0.5-4%. In some embodiments, the content of Ln³⁺ may be approximately 0, greater than 0, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, 5%, 5.5%, 6%, 6.5%, 7%, 7.5%, or 8%.

Compared with La³⁺ and Gd³⁺ in glass, Y³⁺ is more conducive to obtaining the desired spectral characteristics of the present application. Therefore, the content of Y³⁺ is preferably 0-6%, more preferably 0.1-5%, and even more preferably 0.5-3%. The content of La³⁺ is preferably 0-5%, more preferably 0-3%, and even more preferably 0-2%. The content of Gd³⁺ is preferably 0-5%, more preferably 0-3%, and even more preferably 0-2%. In some embodiments, the content of Y³⁺ may be approximately 0, greater than 0, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, 5%, 5.5% or 6%. In some embodiments, the content of La³⁺ may be approximately 0, greater than 0, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, or 5%. In some embodiments, the content of Gd³⁺ may be approximately 0, greater than 0, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, or 5%.

In some embodiments, the ratio of the content of Al³⁺ to Ln³⁺, Al³⁺/Ln³⁺, is controlled to be greater than 0.2, which is beneficial for the glass to obtain a suitable Young's modulus and abrasion resistance. Therefore, it is preferred that Al³⁺/Ln³⁺ is greater than 0.2, more preferably Al³⁺/Ln³⁺ is 0.2-20.0, and further preferably Al³⁺/Ln³⁺ is 0.5-15.0. Furthermore, controlling Al³⁺/Ln³⁺ within the range of 1.0-10.0 is also beneficial for the glass to obtain a higher hardness while preventing the glass transition temperature from increasing. Therefore, it is even more preferred that Al³⁺/Ln³⁺ is 1.0-10.0, and it is further preferred that Al³⁺/Ln³⁺ is 1.5-8.0. In some embodiments, the value of Al³⁺/Ln³⁺ may be 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, 5.0, 5.5, 6.0, 6.5, 6.6, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, or 20.0.

In some embodiments, by controlling P⁵⁺/(Al³⁺+Ln³⁺) within the range of 5.0 to 50.0, the hardness of the glass can be increased and the glass density can be prevented from increasing. Therefore, preferably P⁵⁺/(Al³⁺+Ln³⁺) is 5.0 to 50.0, and more preferably P⁵⁺/(Al³⁺+Ln³⁺) is 10.0 to 35.0. Furthermore, controlling P⁵⁺/(Al³⁺+Ln³⁺) within the range of 12.0 to 30.0 can further improve the visible light transmittance of the glass. Therefore, it is even more preferred that P⁵⁺/(Al³⁺+Ln³⁺) is 12.0 to 30.0, and it is further preferred that P⁵⁺/(Al³⁺+Ln³⁺) is 15.0 to 25.0. In some embodiments, the value of P⁵⁺/(Al³⁺+Ln³⁺) may be 5.0, 6.0, 7.0, 8.0, 9.0, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 43.0, 44.0, 45.0, 46.0, 47.0, 48.0, 49.0, or 50.0.

In some embodiments, controlling Cu²⁺/Ln³⁺ to be greater than 2.0 is beneficial to improving the near-infrared absorption performance of the glass. Therefore, it is preferred that Cu²⁺/Ln³⁺ is greater than 2.0, and more preferably Cu²⁺/Ln³⁺ is 2.0 to 40.0. Further, when Cu²⁺/Ln³⁺ is controlled within the range of 5.0 to 30.0, it is also beneficial to improve the hardness of the glass and reduce the transition temperature. Therefore, it is further preferred that Cu²⁺/Ln³⁺ is within the range of 5.0 to 30.0, more preferably within the range of 8.0 to 20.0, and even more preferably within the range of 10.0 to 15.0. In some embodiments, the value of Cu²⁺/Ln³⁺ may be 2.0, 3.0, 4.0, 5.0, 6.0, 7.0, 8.0, 9.0, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, or 40.0.

Rn⁺ (Rn⁺ is one or more of Li⁺, Na⁺, and K⁺) can reduce the melting temperature and viscosity of the glass, and can promote the presence of more Cu in the form of Cu²⁺, but as Rn⁺ increases, the chemical stability of the glass deteriorates. In the present application, a content of more than 5% Rn⁺ is used to achieve the above properties, but when the content of Rn⁺ exceeds 25%, the devitrification resistance of the glass decreases, the forming performance of the glass deteriorates, and the coefficient of thermal expansion increases. Therefore, the content of Rn⁺ in the present application is 5-25%, preferably 7-20%, and more preferably 10-17%. In some embodiments, the content of Rn⁺ may be approximately 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, or 25%.

Li⁺ can lower the melting temperature and viscosity of glass, improve the visible light transmittance of glass, and its contribution to chemical stability is superior to that of Na⁺ and K⁺. In the present application, it is preferred to include more than 5% Li⁺. However, when the content of Li⁺ exceeds 25%, the glass's resistance to devitrification and formability decrease. Therefore, the lower limit of the content of Li⁺ is preferably 5%, more preferably 8%, and even more preferably 10%. The upper limit of the content of Li⁺ is preferably 25%, more preferably 20%, and even more preferably 16%. In some embodiments, the content of Li⁺ may be approximately 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, or 25%.

Na⁺ is a component that improves the melting property of glass. In the present application, by making the content of Na⁺ less than 10%, the chemical stability of the glass can be improved while preventing the reduction of weather resistance and processability. Preferably, the content of Na⁺ is less than 5%, and more preferably, the content of Na⁺ is less than 2%. In some embodiments, the content of Na⁺ may be approximately 0, greater than 0, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%.

K⁺ can increase the transmittance of glass in the visible light range. When its content exceeds 10%, the stability of the glass decreases. Therefore, the content of K⁺ is less than 10%, preferably the content of K⁺ is less than 5%, and more preferably the content of K⁺ is less than 2%. In some embodiments, the content of K⁺ may be approximately 0, greater than 0, 0.01%, 0.05%, 0.1%, 0.5%, 1%, 1.5%, 2%, 2.5%, 3%, 3.5% 4%, 4.5% 5%, 5.5% 6%, 6.5%, 7%, 7.5% 8%, 8.5%, 9%, 9.5%, or 10%.

R²⁺ (R²⁺ is one or more of Mg²⁺, Ca²⁺, Sr²⁺, and Ba²⁺) can be used to lower the melting temperature and coefficient of thermal expansion of glass, and improve the glass's forming stability and strength. However, when the content of R²⁺ exceeds 18%, the resistance to devitrification of glass decreases. In the present application, the content of R²⁺ is 1-18%, preferably 3-16%, and more preferably 5-14%. In some embodiments, the content of R²⁺ may be approximately 1%, 1.5%, 2%, 2.5%, 3%, 3.5%, 4%, 4.5%, 5%, 5.5%, 6%, 6.5%, 7%, 7.5%, 8%, 8.5%, 9%, 9.5% 10%, 10.5%, 11%, 11.5%, 12%, 12.5%, 13%, 13.5%, 14%, 14.5%, 15%, 15.5%, 16%, 16.5%, 17%, 17.5%, or 18%.

In some embodiments, controlling Ln³⁺/R²⁺ to be greater than 0.01 can optimize the anti-crystallization performance of the glass and help reduce the coefficient of thermal expansion of the glass. Therefore, preferably Ln³⁺/R²⁺ is greater than 0.01, and more preferably Ln³⁺/R²⁺ is 0.01 to 3.0. Further, by controlling Ln³⁺/R²⁺ within the range of 0.03 to 1.0, it is also beneficial to improve the near-infrared absorption performance of the glass. Therefore, it is even more preferred that Ln³⁺/R²⁺ is 0.03 to 1.0, it is further preferred that Ln³⁺/R²⁺ is 0.05 to 0.8, and it is still further preferred that Ln³⁺/R²⁺ is 0.07 to 0.5. In some embodiments, the value of Ln³⁺/R²⁺ may be 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0.

In some embodiments, by controlling P⁵⁺/R²⁺ within the range of 3.0 to 30.0, it is beneficial to improve the chemical stability of the glass and reduce the density and coefficient of thermal expansion of the glass. Therefore, preferably P⁵⁺/R²⁺ is 3.0 to 30.0, more preferably P⁵⁺/R²⁺ is 3.5 to 25.0, further preferably P⁵⁺/R²⁺ is 4.0 to 20.0, and still further preferably P⁵⁺/Rn²⁺ is 5.0 to 10.0. In some embodiments, the value of P⁵⁺/R²⁺ may be 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, or 30.0.

Mg²⁺ can reduce the melting temperature of glass and improve the processing performance of glass. If its content exceeds 15%, the anti-crystallization performance of glass decreases. Therefore, the content of Mg²⁺ is less than 15%, preferably 0.5-10%, and more preferably 2-8%. In some embodiments, the content of Mg²⁺ may be approximately 0, greater than 0, 0.1%, 0.5%, 1%, 1.5%, 2%, 2.5%, 3%, 3.5% 4%, 4.5% 5%, 5.5% 6%, 6.5%, 7%, 7.5% 8%, 8.5%, 9%, 9.5%, 10%, 10.5%, 11%, 11.5%, 12%, 12.5%, 13%, 13.5%, 14%, 14.5%, or 15%.

In some embodiments, the value of Li⁺/(Mg²⁺+Al³⁺) is controlled within the range of 0.4 to 10.0, which can make the glass have excellent transmittance in the visible light range, improve the near-infrared absorption of the glass, and prevent the glass density and coefficient of thermal expansion from increasing. Therefore, preferably Li⁺/(Mg²⁺+Al³⁺) is 0.4 to 10.0, more preferably Li⁺/(Mg²⁺+Al³⁺) is 0.6 to 7.0, even more preferably Li⁺/(Mg²⁺+Al³⁺) is 1.0 to 5.0, and further preferably Li⁺/(Mg²⁺+Al³⁺) is 1.2 to 3.0. In some embodiments, the value of Li⁺/(Mg²⁺+Al³⁺) may be 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4. 0.4, 3.5, 3.6, 3.7, 3.8, 3.9, 4.0, 4.1, 4.2, 4.3, 4.4, 4.5, 4.6, 4.7, 4.8, 4.9, 5.0, 5.3, 5.5, 5.7, 6.0, 6.3, 6.5, 6.7, 7.0, 7.3, 7.5, 7.7, 8.0, 8.3, 8.5, 8.7, 9.0, 9.3, 9.5, 9.7, or 10.0.

In some embodiments, by controlling the value of (Cu²⁺+Mg²⁺)/(Li⁺+Al³⁺) within the range of 0.3 to 6.0, the hardness of the glass can be improved while having a suitable Young's modulus. Therefore, it is preferred that (Cu²⁺+Mg²⁺)/(Li⁺+Al³⁺) is 0.3 to 6.0, more preferably (Cu²⁺+Mg²⁺)/(Li⁺+Al³⁺) is 0.5 to 5.0, even more preferably (Cu²⁺+Mg²⁺)/(Li⁺+Al³⁺) is 0.7 to 3.0, and further preferably (Cu²⁺+Mg²⁺)/(Li⁺+Al³⁺) is 0.8 to 2.0. In some embodiments, the value of (Cu²⁺+Mg²⁺)/(Li⁺+Al³⁺) may be 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0.

By including less than 10% of Ca²⁺, the glass can prevent the reduction of anti-crystallization performance while reducing high temperature viscosity. The content of Ca²⁺ is preferably less than 5%, and more preferably less than 2%. In some embodiments, the content of Ca²⁺ may be approximately 0, greater than 0, 0.01%, 0.05%, 0.1%, 0.5%, 1%, 1.5%, 2%, 2.5%, 3%, 3.5%, 4%, 4.5%, 5%, 5.5%, 6%, 6.5%, 7% 7.5%, 8%, 8.5%, 9% 9.5%, or 10%.

By including less than 10% Sr²⁺, the chemical stability and anti-crystallization performance of the glass can be prevented from being reduced. Preferably, the content of Sr²⁺ is less than 5%, and more preferably less than 2%. In some embodiments, the content of Sr²⁺ may be approximately 0, greater than 0, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%.

Ba²⁺ can increase the transmittance of glass in the visible light range, improve the glass forming stability and strength of glass, and if its content exceeds 10%, the density of glass increases. In some embodiments of the present application, by making the content of Ba²⁺ more than 0.5%, the chemical stability of glass can be improved and the thermal expansion coefficient of glass can be reduced. Therefore, the content of Ba²⁺ is less than 10%, preferably the content of Ba²⁺ is 0.5-8%, and more preferably the content of Ba²⁺ is 1-6%. In some embodiments, the content of Ba²⁺ may be approximately 0, greater than 0, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9% 9.5%, or 10%.

In some embodiments, by making Ln³⁺/(Ba²⁺+Al³⁺) more than 0.02, it is beneficial to prevent the transition temperature from rising while reducing the thermal expansion coefficient of the glass. Therefore, it is preferred that Ln³⁺/(Ba²⁺+Al³⁺) is more than 0.02, more preferably Ln³⁺/(Ba²⁺+Al³⁺) is 0.02 to 2.0, and even more preferably Ln³⁺/(Ba²⁺+Al³⁺) is 0.05 to 1.0. Furthermore, by controlling Ln³⁺/(Ba²⁺+Al³⁺) within the range of 0.08 to 0.8, it is also beneficial to optimize the hardness of the glass. Therefore, it is further preferred that Ln³⁺/(Ba²⁺+Al³⁺) is 0.08-0.8, and it is still further preferred that Ln³⁺/(Ba²⁺+Al³⁺) is 0.1-0.5.

B³⁺ can reduce the melting temperature of glass. When its content exceeds 5%, the near-infrared light absorption characteristics are reduced. Therefore, the content of B³⁺ is 0-5%, preferably 0-2%, more preferably 0-1%, and it is further preferred that the glass does not include B³⁺. In some embodiments, the content of B³⁺ may be approximately 0, greater than 0, 0.01%, 0.05%, 0.1%, 0.5%1, %, 1.5%, 2%, 2.5%, 3%, 3.5%, 4%, 4.5%, or 5%.

Si⁴⁺ can promote the formation of glass and improve the chemical stability of glass. When its content exceeds 5%, the meltability of glass deteriorates, and it is easy to form unmelted impurities in the glass. At the same time, the near-infrared light absorption characteristics of glass are easily reduced. Therefore, the content of Si⁴⁺ is 0-5%, preferably 0-2%, more preferably 0-1%, and it is further preferred that the glass does not include Si⁴⁺. In some embodiments, the content of Si⁴⁺ may be approximately 0, greater than 0, 0.01%, 0.05%, 0.1%, 0.5%, 1%, 1.5%, 2%, 2.5%, 3%, 3.5%, 4%, 4.5%, or 5% of Si⁴⁺.

Zn²⁺ can lower the transition temperature of glass and improve the thermal stability of glass. When its content exceeds 10%, the devitrification resistance of the glass decreases. Therefore, the content of Zn²⁺ is limited to less than 10%, preferably less than 5%, and more preferably less than 2%. In some embodiments, it is further preferred that the glass does not include Zn²⁺. In some embodiments, the content of Zn²⁺ may be approximately 0, greater than 0, 0.01%, 0.05%, 0.1%, 0.5%1, %, 1.5%, 2%, 2.5%, 3%, 3.5%, 4%, 4.5%, or 5%.

Zr⁴⁺ can improve the chemical stability of glass, but if its content exceeds 5%, the melting performance of the glass will significantly decrease, and the anti-crystallization performance will decrease. Therefore, the content of Zr⁴⁺ is limited to 0 to 5%, preferably 0 to 2%, more preferably 0 to 1%, and further preferably that the glass does not include Zr⁴⁺. In some embodiments, the content of Zr⁴⁺ may be approximately 0, greater than 0, 0.01%, 0.05%, 0.1%, 0.5%, 1%, 1.5%, 2%, 2.5%, 3%, 3.5%, 4%, 4.5%, or 5%.

One or more components of Sb³⁺, Sn⁴⁺, and Ce⁴⁺ can be used as a clarifying agent to enhance the clarification effect of the glass and improve the glass's bubble grade. The individual or total content of Sb³⁺, Sn⁴⁺, and Ce⁴⁺ is 0 to 1%, preferably 0 to 0.5%, and more preferably 0 to 0.1%. In some embodiments, the content of Sb³⁺ and/or Sn⁴⁺ and/or Ce⁴⁺ may be approximately 0, greater than 0, 0.01%, 0.05%, 0.1%, 0.2%, 0.3%, 0.4%, 0.5%, 0.6%, 0.7%, 0.8%, 0.9%, or 1%.

### <Anionic Component>

The anionic components of the glass of the present application mainly include O²⁻ and F⁻. In order to make the glass of the present application have excellent stability and devitrification resistance, the total content of O²⁻ and F⁻, O²⁻+F⁻, is more than 98%, preferably more than 99, and more preferably, it is more than 99.5%. In some embodiments, O²⁻+F⁻ may be 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8%, 99.9%, or 100%.

O²⁻ is an important anionic component in the glass of the present application. It can stabilize the network structure and form stable glass. It can also ensure that Cu ions in the glass exist in the form of Cu²⁺, thereby ensuring the glass's ability to absorb light in the near-infrared range. If the content of O²⁻ is too low, it will be difficult to form stable glass, and Cu²⁺ will be easily reduced to Cu²⁺, making it difficult to achieve the effect of light absorption in the near-infrared range. However, if the content of O²⁻ is excessive, the melting temperature of the glass will be higher. This results in a significant decrease in light transmittance in the visible light range. Therefore, the content of O²⁻ is limited to 85-99.5%, preferably 88-99%, and more preferably 91-98%. In some embodiments, the content of O²⁻ may be approximately 85%, 85.5%, 86%, 86.5%, 87%, 87.5%, 88%, 88.5%, 89%, 89.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, or 99.5%.

F⁻ can reduce the melting temperature of glass, and can improve the visible light transmittance of glass, reduce the viscosity of glass, and the appropriate amount of F⁻ is beneficial to improve the anti-crystallization performance of glass. If the content of F⁻ exceeds 15%, the stability of the glass is reduced, the glass is easy to volatilize during melting, pollute the environment, and the glass is prone to forming streaks. Therefore, the content of F⁻ is limited to 0.5-15%, preferably 1-12%, and more preferably 2-9%. In some embodiments, the content of F⁻ may be approximately 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, or 15%.

In some embodiments, by controlling Ln³⁺/F⁻ to be more than 0.01, it prevents the glass transition temperature from rising, while improving the near-infrared absorption performance of glass. Therefore, Ln³⁺/F⁻ is preferably more than 0.01, more preferably Ln³⁺/F⁻ is 0.02 to 10.0, and further preferably Ln³⁺/F⁻ is 0.05 to 5.0. Furthermore, by controlling Ln³⁺/F⁻ in the range of 0.05 to 2.0, the glass can also obtain a suitable Young's modulus. Therefore, Ln³⁺/F⁻ is further preferably 0.05 to 2.0, and still further preferably Ln³⁺/F⁻ is 0.1 to 1.0. In some embodiments, the value of Ln³⁺/F⁻ may be 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, 7.5, 8.0, 8.5, 9.0, 9.5, or 10.0.

In some embodiments, by controlling F/Cu²⁺ in the range of 0.05 to 2.0, the glass can obtain a suitable Young's modulus and a lower coefficient of thermal expansion. Therefore, the preferred F⁻/Cu²⁺ is 0.05 to 2.0, the more preferred F⁻/Cu²⁺ is 0.1 to 1.5, the further preferred F⁻/Cu²⁺ is 0.2 to 1.0, and the still further preferred F/Cu²⁺ is 0.3 to 0.8. In some embodiments, the value of F/Cu²⁺ may be 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, or 2.0.

One or more of Cl⁻, Br⁻, and I⁻ can be used as a clarifying agent to enhance the clarification effect of the glass and improve the glass's bubble grade. The individual or total content of Cl⁻, Br⁻, and I⁻ is 0-2%, preferably 0-1%, and more preferably 0-0.5%. In some embodiments, the content of Cl⁻ and/or Br⁻ and/or I⁻ may be approximately 0, greater than 0, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, or 2%.

### <Components not Included>

Components such as V, Cr, Mn, Fe, Co, Ni, Ag, and Mo, even if included in small amounts alone or in combination, will interfere with the spectral transmittance of the glass, which is not conducive to the formation of the glass of the present application. Therefore, it is preferred not to include the above components.

Components such as As, Pb, Th, Cd, Tl, Os, Be and Se, there is a trend of restricting the use of these components chemicals as hazardous chemicals. Environmental protection measures are necessary not only in the manufacturing process of glass, but also in the processing process and disposal after productization. Therefore, with attention paid to the impact on the environment, it is preferred that they are not actually included except for the inevitable mixing. As a result, the glass does not actually include substances that pollute the environment. Therefore, even without taking special environmental countermeasures, the glass of the present application can be manufactured, processed and discarded.

The “not include” and “0%” recorded in this application mean that the component is not intentionally added as a raw material to the glass of the present application; however, as the raw materials and/or equipment for producing glass, there will be some impurities or components that are not intentionally added, which will be included in a small amount or trace amount in the final glass, and this situation is also within the scope of protection of the present application.

### <Manufacturing Method>

The manufacturing method of the glass of the present application is as follows: the glass of the present application is produced by conventional raw materials and conventional processes, using carbonates, nitrates, phosphates, metaphosphates, sulfates, hydroxides, oxides, fluorides, etc. as raw materials, and after the ingredients are prepared, according to the conventional method, the prepared furnace materials are put into a melting furnace at 700-1000° C. for melting, and after clarification, stirring and homogenization, a homogeneous molten glass without bubbles and undissolved substances is obtained, and the molten glass is cast in a mold and annealed. Those skilled in the art can appropriately select raw materials, process methods and process parameters according to practical needs.

The glass of the present application can also be formed by well-known methods. In some embodiments, the glass described herein can be manufactured into shaped articles by various processes, and the shaped articles include but is not limited to sheets, and the process includes but is not limited to slot drawing, float process, rolling and other processes for forming sheets known in the art. Alternatively, the glass can be formed by a float process or rolling process known in the art.

The glass of the present application can be manufactured into glass shaped articles of sheets by grinding or polishing, but the method for manufacturing glass shaped articles is not limited to these methods.

The glass and glass forming bodies of the present application may have any reasonable and useful thickness.

Below, the properties of the glass of the present application are described.

### <Transition Temperature>

The transition temperature (T_{g}) of the glass is tested according to the method specified in GB/T7962.16-2010.

In some embodiments, the transition temperature (T_{g}) of the glass of the present application is less than 410° C., preferably less than 400° C., more preferably 390° C. or less, and further preferably 370-390° C.

### <Density>

The density (ρ) of the glass is tested according to the method specified in GB/T7962.20-2010.

In some embodiments, the density (ρ) of the glass of the present application is less than 3.3 g/cm³, preferably less than 3.2 g/cm³, more preferably less than 3.1 g/cm³, and further preferably less than 3.0 g/cm³.

### <Coefficient of Thermal Expansion>

The coefficient of thermal expansion (α_{20-120° C.}) of the glass is tested according to the method specified in GB/T7962.16-2010.

In some embodiments, the coefficient of thermal expansion (α_{20-120° C.}) of the glass of the present application is less than 110×10⁻⁷/K or less, preferably less than 100×10⁻⁷/K, and more preferably less than 95×10⁻⁷/K.

### <Hardness>

The hardness (Hᵥ) of the glass is tested by the following method: the load (N) when a diamond pyramid indenter with a face angle of 1360 is pressed into a pyramid-shaped depression on the test surface being divided by the surface area (mm²) calculated by the length of the depression. The test load is set to 100 N and the holding time is 15 seconds.

In some embodiments, the hardness (Hᵥ) of the glass of the present application is above 380 kgf/mm², preferably above 390 kgf/mm², more preferably above 400 kgf/mm², and further preferably above 410 kgf/mm².

### <Young's Modulus>

The Young's modulus (E) of the glass is determined by measuring the longitudinal wave velocity and transverse wave velocity using ultrasonic testing, and then calculated using the following formula:

$$E = \frac{4 {G}^{2} - 3 {{GV}_{T}}^{2} ρ}{G - {{V}_{T}}^{2} ρ}$$

Wherein:

E is the Young's modulus, in Pa;

G is the shear modulus, in Pa;

V_{T} is the transverse wave velocity, in m/s;

Vₛ is the longitudinal wave velocity, in m/s;

ρ is the glass density, in g/cm³.

In some embodiments, the lower limit of the Young's modulus (E) of the glass according to the present application is 5500×10⁷/Pa, preferably 6000×10⁷/Pa, more preferably 6500×10⁷/Pa, and the upper limit of the Young's modulus (E) is 8500×10⁷/Pa, preferably 8000×10⁷/Pa, more preferably 7500×10⁷/Pa.

### <Spectral Transmittance>

The spectral transmittance of the glass of the present application refers to the value obtained by a spectrophotometer in the following manner: assuming that the glass sample has two parallel and optically polished surfaces, light is perpendicularly incident on one parallel surface and exits from the other parallel surface, the intensity of the emergent light divided by the intensity of the incident light is the transmittance, and this transmittance is also referred to as external transmittance.

In some embodiments, when the glass thickness is less than 0.5 mm, the spectral transmittance exhibits the following characteristics.

The spectral transmittance at a wavelength of 400 nm (T₄₀₀) is higher than 80.0%, preferably higher than 82.0%, and more preferably higher than 84.0%.

In some embodiments, τ₄₀₀ may be 80.0%, 80.1%, 80.2%, 80.3%, 80.4%, 80.5%, 80.6%, 80.7%, 80.8%, 80.9%, 81.0%, 81.1%, 81.2%, 81.3%, 81.4%, 81.5%, 81.6%, 81.7%, 81.8%, 81.9%, 82.0%, 82.1%, 82.2%, 82.3%, 82.4%, 82.5%, 82.6%, 82.7%, 82.8%, 82.9%, 83.0%, 83.1%, 83.2%, 83.3%, 83.4%, 83.5%, 83.6%, 83.7%, 83.8%, 83.9%, 84.0%, 84.1%, 84.2%, 84.3%, 84.4%, 84.5%, 84.6%, 84.7%, 84.8%, 84.9%, 85.0%, 85.1%, 85.2%, 85.3%, 85.4%, 85.5%, 85.6%, 85.7%, 85.8%, 85.9%, 86.0%, 86.1%, 86.2%, 86.3%, 86.4%, 86.5%, 86.6%, 86.7%, 86.8%, 86.9%, 87.0%, 87.1%, 87.2%, 87.3%, 87.4%, 87.5%, 87.6%, 87.7%, 87.8%, 87.9%, 88.0%, 88.1%, 88.2%, 88.3%, 88.4%, 88.5%, 88.6%, 88.7%, 88.8%, 88.9%, 89.0%, 89.5%, 90.0%, 90.5%, 91.0%, 91.5%, or 92.0%.

The spectral transmittance at a wavelength of 500 nm (τ₅₀₀) is higher than 83.0%, preferably higher than 85.0%, and more preferably higher than 88.0%.

In some embodiments, τ₅₀₀ may be 83.0%, 83.1%, 83.2%, 83.3%, 83.4%, 83.5%, 83.6%, 83.7%, 83.8%, 83.9%, 84.0%, 84.1%, 84.2%, 84.3%, 84.4%, 84.5%, 84.6%, 84.7%, 84.8%, 84.9%, 85.0%, 85.1%, 85.2%, 85.3%, 85.4%, 85.5%, 85.6%, 85.7%, 85.8%, 85.9%, 86.0%, 86.1%, 86.2%, 86.3%, 86.4%, 86.5%, 86.6%, 86.7%, 86.8%, 86.9%, 87.0%, 87.1%, 87.2%, 87.3%, 87.4%, 87.5%, 87.6%, 87.7%, 87.8%, 87.9%, 88.0%, 88.1%, 88.2%, 88.3%, 88.4%, 88.5%, 88.6%, 88.7%, 88.8%, 88.9%, 89.0%, 89.1%, 89.2%, 89.3%, 89.4%, 89.5%, 89.6%, 89.7%, 89.8%, 89.9%, 90.0%, 90.1%, 90.2%, 90.3%, 90.4%, 90.5%, 90.6%, 90.7%, 90.8%, 90.9%, 91.0%, 91.1%, 91.2%, 91.3%, 91.4%, 91.5%, 91.6%, 91.7%, 91.8%, 91.9%, 92.0%, 92.5%, 93.0%, 93.5%, 94.0%, 94.5%, or 95.0%.

The spectral transmittance at a wavelength of 1100 nm (τ₁₁₀₀) is 10.0% or less, preferably 7.0% or less, more preferably 5.0% or less, and further preferably 3.0% or less.

In some embodiments, τ₁₁₀₀ may be 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.5%, 4.0%, 4.5% 5.0%, 5.5%, 6.0%, 6.5%, 7.0%, 7.5% 8.0%, 8.5%, 9.0%, 9.5%, or 10.0%.

In some embodiments, when the glass thickness is less than 0.5 mm, in the spectral transmittance within the wavelength range of 500 to 700 nm, the wavelength (λ₅₀) corresponding to 50% transmittance is less than 635 nm, preferably 600 to 630 nm, and more preferably 610 to 625 nm.

In some embodiments, λ₅₀ is 600 nm, 601 nm, 602 nm, 603 nm, 604 nm, 605 nm, 606 nm, 607 nm, 608 nm, 609 nm, 610 nm, 611 nm, 612 nm, 613 nm, 614 nm, 615 nm, 616 nm, 617 nm, 618 nm, 619 nm, 620 nm, 621 nm, 622 nm, 623 nm, 624 nm, 625 nm, 626 nm, 627 nm, 628 nm, 629 nm, 630 nm, 631 nm, 632 nm, 633 nm, 634 nm, or 635 nm.

In the above spectral transmittance tests, the thickness of the glass is preferably 0.05 to 0.4 mm, more preferably 0.1 to 0.3 mm, and further preferably 0.1 mm, 0.15 mm, 0.2 mm, or 0.25 mm.

### <Glass Element>

The glass element related to the present application includes the aforementioned glass, and can be exemplified as a thin plate-shaped glass element or lens used in near-infrared light absorption filters, suitable for color correction applications of solid-state imaging elements, and possessing various excellent properties of the above glass. Furthermore, the thickness of the glass element (the distance between the incident surface and the emitting surface of the transmitted light) is determined by the transmittance characteristics of the element, and is preferably 0.05 to 0.4 mm, more preferably 0.1 to 0.3 mm, and further preferably 0.1 mm, 0.15 mm, 0.2 mm, or 0.25 mm. In the spectral transmittance within the wavelength range of 500 to 700 nm, the wavelength (λ₅₀) corresponding to the transmittance of 50% is less than 635 nm, preferably 600 to 630 nm, and more preferably 610 to 625 nm. In order to obtain such a glass element, the composition of the glass is adjusted and processed into an element having the above-mentioned spectral characteristic thickness.

### <Filter>

The filter related to the present application is a near-infrared filter, which includes the above-mentioned glass or the above-mentioned glass element, and has a near-infrared light absorbing element made of near-infrared light absorbing glass with both sides optically polished. This element gives the filter a color correction function, and also has various excellent properties of the above-mentioned glass.

### <Devices>

The glass, or glass element, or filter of the present application can be used to make devices by well-known methods, such as portable communication devices (such as mobile phones), smart wearable devices, camera devices, video devices, display devices and monitoring devices.

### Example

### <Example of Glass>

In order to further clearly explain and illustrate the technical solution of the present application, the following non-limiting examples are provided.

This example adopts the above-mentioned glass manufacturing method to obtain glass having the composition shown in Tables 1 to 3. In addition, the characteristics of each glass are measured by the test method described in the present application, and the measurement results are shown in Tables 1 to 3.

TABLE 1

| Components (mol %) | | 1# | 2# | 3# | 4# | 5# | 6# | 7# | 8# |
|---|---|---|---|---|---|---|---|---|---|
| Cations | P⁵⁺ | 56.2 | 58.7 | 62.4 | 64.8 | 65.5 | 60.6 | 66.3 | 55.7 |
| | Al³⁺ | 7 | 3.5 | 2.6 | 1.7 | 3.6 | 3.2 | 2.7 | 6.5 |
| | Ba³⁺ | 0.8 | 2.3 | 0 | 1.5 | 2.5 | 2.7 | 3.8 | 6.3 |
| | Mg²⁺ | 1.5 | 3.1 | 12 | 10.4 | 8.5 | 6.4 | 3.6 | 4.8 |
| | Sr²⁺ | 0 | 0 | 0.5 | 0 | 0 | 0 | 0 | 0 |
| | Ca²⁺ | 0 | 0 | 0 | 0 | 0 | 0 | 1 | 0 |
| | Zn²⁺ | 0.5 | 0 | 0 | 0 | 0 | 0 | 0 | 0 |
| | Li⁺ | 18.4 | 20.6 | 12.1 | 9.3 | 6.5 | 14.3 | 10.4 | 12 |
| | Na⁺ | 0.5 | 0 | 0 | 0 | 0 | 0 | 0 | 1.5 |
| | K⁺ | 0 | 0 | 0 | 0 | 0 | 0 | 0 | 0 |
| | Y³⁺ | 0.5 | 1.5 | 0.6 | 2.4 | 1.7 | 2.5 | 1.1 | 1.7 |
| | La³⁺ | 0.1 | 0 | 0.3 | 0 | 0 | 0 | 0.2 | 0 |
| | Gd³⁺ | 0 | 0 | 0 | 0 | 0.2 | 0 | 0.3 | 0 |
| | Cu²⁺ | 14.5 | 10.2 | 9.5 | 8.3 | 11.5 | 10.3 | 10.6 | 11.5 |
| | Si⁴⁺ | 0 | 0 | 0 | 1 | 0 | 0 | 0 | 0 |
| | Zr⁴⁺ | 0 | 0 | 0 | 0.5 | 0 | 0 | 0 | 0 |
| | B³⁺ | 0 | 0 | 0 | 0 | 0 | 0 | 0 | 0 |
| | Sb³⁺ | 0 | 0.1 | 0 | 0.1 | 0 | 0 | 0 | 0 |
| | Sn²⁺ | 0 | 0 | 0 | 0 | 0 | 0 | 0 | 0 |
| | Ce⁴⁺ | 0 | 0 | 0 | 0 | 0 | 0 | 0 | 0 |
| | Total | 100 | 100 | 100 | 100 | 100 | 100 | 100 | 100 |
| Anions | O²⁻ | 88.5 | 86.5 | 90.2 | 91.5 | 89.3 | 93.5 | 94.7 | 92.5 |
| | F⁻ | 11.5 | 13.5 | 9.6 | 8.5 | 10.6 | 6.5 | 5.3 | 7.5 |
| | Cl⁻ | 0 | 0 | 0.2 | 0 | 0.1 | 0 | 0 | 0 |
| | Br⁻ | 0 | 0 | 0 | 0 | 0 | 0 | 0 | 0 |
| | I⁻ | 0 | 0 | 0 | 0 | 0 | 0 | 0 | 0 |
| | Total | 100 | 100 | 100 | 100 | 100 | 100 | 100 | 100 |

| | | | | | | | | |
|---|---|---|---|---|---|---|---|---|
| R²⁺ | 2.3 | 5.4 | 12.5 | 11.9 | 11 | 9.1 | 8.4 | 11.1 |
| Rn⁺ | 18.9 | 20.6 | 12.1 | 9.3 | 6.5 | 14.3 | 10.4 | 13.5 |
| Ln³⁺ | 0.6 | 1.5 | 0.9 | 2.4 | 1.9 | 2.5 | 1.6 | 1.7 |
| Al³⁺/Ln³⁺ | 11.67 | 2.333 | 2.889 | 0.708 | 1.895 | 1.28 | 1.688 | 3.824 |
| Li⁺/(Mg²⁺ + Al³⁺) | 2.165 | 3.121 | 0.829 | 0.769 | 0.537 | 1.49 | 1.651 | 1.062 |
| Cu²⁺/Al³⁺ | 2.071 | 2.914 | 3.654 | 4.882 | 3.194 | 3.219 | 3.926 | 1.769 |
| (Cu²⁺ + Mg²⁺)/ | 0.63 | 0.552 | 1.463 | 1.7 | 1.98 | 0.954 | 1.084 | 0.881 |
| (Li⁺ + Al³⁺) | | | | | | | | |
| Ln³⁺/R²⁺ | 0.261 | 0.278 | 0.072 | 0.202 | 0.173 | 0.275 | 0.19 | 0.153 |
| Ln³⁺/(Ba³⁺ + Al³⁺) | 0.077 | 0.259 | 0.346 | 0.75 | 0.311 | 0.424 | 0.246 | 0.133 |
| P⁵⁺/(Al³⁺ + Ln³⁺) | 7.395 | 11.74 | 17.83 | 15.8 | 11.91 | 10.63 | 15.42 | 6.793 |
| Cu²⁺/Ln³⁺ | 24.17 | 6.8 | 10.56 | 3.458 | 6.053 | 4.12 | 6.625 | 6.765 |
| P⁵⁺/R²⁺ | 24.43 | 10.87 | 4.992 | 5.445 | 5.955 | 6.659 | 7.893 | 5.018 |
| Ln³⁺/F⁻ | 0.052 | 0.111 | 0.094 | 0.282 | 0.179 | 0.385 | 0.302 | 0.227 |
| F⁻/Cu²⁺ | 0.793 | 1.324 | 1.011 | 1.024 | 0.922 | 0.631 | 0.5 | 0.652 |
| T_{g}(° C.) | 395 | 386 | 385 | 394 | 387 | 386 | 389 | 390 |
| α_{20-120° C.}(×10⁻⁷/K) | 96 | 92 | 95 | 97 | 95 | 85 | 83 | 84 |
| ρ(g/cm³) | 2.96 | 2.95 | 2.95 | 2.88 | 2.97 | 2.89 | 2.82 | 2.90 |
| Hᵥ(kgf/mm²) | 415 | 418 | 425 | 417 | 420 | 421 | 426 | 422 |
| E(×10⁷ Pa) | 6945 | 6958 | 7010 | 7005 | 7022 | 7015 | 7125 | 7027 |

TABLE 2

| Components (mol %) | | 9# | 10# | 11# | 12# | 13# | 14# | 15# | 16# |
|---|---|---|---|---|---|---|---|---|---|
| Cations | P⁵⁺ | 57.6 | 61.8 | 62.2 | 60.7 | 63.5 | 65.7 | 68.2 | 69 |
| | Al³⁺ | 3.5 | 2.7 | 1.6 | 4.5 | 2.8 | 3.3 | 4.5 | 1 |
| | Ba³⁺ | 2.2 | 1.8 | 0.7 | 3.6 | 2.7 | 2.5 | 1.6 | 1.8 |
| | Mg²⁺ | 6.2 | 5.5 | 3.7 | 2.5 | 3.5 | 5.2 | 4.6 | 2.8 |
| | Sr²⁺ | 0 | 0 | 0 | 0 | 0 | 0 | 0 | 0 |
| | Ca²⁺ | 0 | 0 | 0 | 0 | 0 | 0 | 0 | 0 |
| | Zn²⁺ | 1 | 0 | 0.5 | 0 | 0 | 0 | 0 | 0 |
| | Li⁺ | 14.4 | 13.1 | 9.6 | 10.9 | 10.1 | 12.4 | 11.1 | 16.9 |
| | Na⁺ | 0 | 0 | 0 | 0 | 0 | 0 | 0 | 0 |
| | K⁺ | 0.5 | 0 | 0 | 0 | 0 | 0 | 0 | 0 |
| | Y³⁺ | 0.8 | 1.6 | 1.5 | 0 | 2.2 | 3.4 | 1.5 | 0.8 |
| | La³⁺ | 0 | 0 | 0 | 1.4 | 0 | 0 | 0 | 0 |
| | Gd³⁺ | 0 | 0 | 0 | 0 | 0 | 0 | 0 | 0 |
| | Cu²⁺ | 12.2 | 13.5 | 20.2 | 16.4 | 15.2 | 7.5 | 8.5 | 6.5 |
| | Si⁴⁺ | 0.5 | 0 | 0 | 0 | 0 | 0 | 0 | 1.2 |
| | Zr⁴⁺ | 0 | 0 | 0 | 0 | 0 | 0 | 0 | 0 |
| | B³⁺ | 1 | 0 | 0 | 0 | 0 | 0 | 0 | 0 |
| | Sb³⁺ | 0 | 0 | 0 | 0 | 0 | 0 | 0 | 0 |
| | Sn²⁺ | 0.1 | 0 | 0 | 0 | 0 | 0 | 0 | 0 |
| | Ce⁴⁺ | 0 | 0 | 0 | 0 | 0 | 0 | 0 | 0 |
| | Total | 100 | 100 | 100 | 100 | 100 | 100 | 100 | 100 |
| Anions | O²⁻ | 96.3 | 95.4 | 92.5 | 96.1 | 94.5 | 96.7 | 98.2 | 97.4 |
| | F⁻ | 3.7 | 4.6 | 7.5 | 3.9 | 5.5 | 3.3 | 1.8 | 2.6 |
| | Cl⁻ | 0 | 0 | 0 | 0 | 0 | 0 | 0 | 0 |
| | Br⁻ | 0 | 0 | 0 | 0 | 0 | 0 | 0 | 0 |
| | I⁻ | 0 | 0 | 0 | 0 | 0 | 0 | 0 | 0 |
| | Total | 100 | 100 | 100 | 100 | 100 | 100 | 100 | 100 |

| | | | | | | | | |
|---|---|---|---|---|---|---|---|---|
| R²⁺ | 8.4 | 7.3 | 4.4 | 6.1 | 6.2 | 7.7 | 6.2 | 4.6 |
| Rn⁺ | 14.9 | 13.1 | 9.6 | 10.9 | 10.1 | 12.4 | 11.1 | 16.9 |
| Ln³⁺ | 0.8 | 1.6 | 1.5 | 1.4 | 2.2 | 3.4 | 1.5 | 0.8 |
| Al³⁺/Ln³⁺ | 4.375 | 1.688 | 1.067 | 3.214 | 1.273 | 0.971 | 3 | 1.25 |
| Li⁺/(Mg²⁺ + Al³⁺) | 1.485 | 1.598 | 1.811 | 1.557 | 1.603 | 1.459 | 1.22 | 4.447 |
| Cu²⁺/Al³⁺ | 3.486 | 5 | 12.63 | 3.644 | 5.429 | 2.273 | 1.889 | 6.5 |
| (Cu²⁺ + Mg²⁺)/ | 1.028 | 1.203 | 2.134 | 1.227 | 1.45 | 0.809 | 0.84 | 0.52 |
| (Li⁺ + Al³⁺) | | | | | | | | |
| Ln³⁺/R²⁺ | 0.095 | 0.219 | 0.341 | 0.23 | 0.355 | 0.442 | 0.242 | 0.174 |
| Ln³⁺/(Ba³⁺ + Al³⁺) | 0.14 | 0.356 | 0.652 | 0.173 | 0.4 | 0.586 | 0.246 | 0.286 |
| P⁵⁺/(Al³⁺ + Ln³⁺) | 13.4 | 14.37 | 20.06 | 10.29 | 12.7 | 9.806 | 11.37 | 38.33 |
| Cu²⁺/Ln³⁺ | 15.25 | 8.438 | 13.47 | 11.71 | 6.909 | 2.206 | 5.667 | 8.125 |
| P⁵⁺/R²⁺ | 6.857 | 8.466 | 14.14 | 9.951 | 10.24 | 8.532 | 11 | 15 |
| Ln³⁺/F⁻ | 0.216 | 0.348 | 0.2 | 0.359 | 0.4 | 1.03 | 0.833 | 0.308 |
| F⁻/Cu²⁺ | 0.303 | 0.341 | 0.371 | 0.238 | 0.362 | 0.44 | 0.212 | 0.4 |
| T_{g}(° C.) | 388 | 380 | 391 | 385 | 392 | 395 | 387 | 393 |
| α_{20-120° C.}(×10⁻⁷/K) | 86 | 88 | 93 | 91 | 83 | 93 | 94 | 93 |
| ρ(g/cm³) | 2.92 | 2.91 | 2.89 | 2.91 | 2.88 | 2.94 | 2.95 | 2.98 |
| Hᵥ(kgf/mm²) | 427 | 428 | 421 | 424 | 419 | 415 | 423 | 417 |
| E(×10⁷ Pa) | 7098 | 7225 | 6970 | 7016 | 7054 | 6975 | 7004 | 7012 |

TABLE 3

| Components (mol %) | | 17# | 18# | 19# | 20# | 21# | 22# | 23# | 24# |
|---|---|---|---|---|---|---|---|---|---|
| Cations | P⁵⁺ | 54.8 | 59.2 | 61.5 | 63.7 | 62.5 | 65.4 | 62.5 | 61.6 |
| | Al³⁺ | 6.2 | 2.7 | 2.5 | 3.3 | 2.5 | 1.6 | 2.4 | 3.6 |
| | Ba³⁺ | 4.5 | 2.2 | 2.8 | 1.6 | 7.2 | 3.5 | 2.1 | 3.5 |
| | Mg²⁺ | 3 | 4.4 | 3.6 | 5.4 | 0 | 2.5 | 3.4 | 4.5 |
| | Sr²⁺ | 0 | 0 | 0 | 0 | 0 | 0 | 0 | 0 |
| | Ca²⁺ | 0 | 3.6 | 0 | 0 | 0 | 0 | 0 | 0 |
| | Zn²⁺ | 0 | 0 | 0 | 0 | 0 | 0 | 0 | 0 |
| | Li⁺ | 17.8 | 14.5 | 16.4 | 10.8 | 12.8 | 11.1 | 15.3 | 14.6 |
| | Na⁺ | 0 | 0 | 0 | 0 | 0 | 0 | 0 | 0 |
| | K⁺ | 0 | 0 | 0 | 0 | 1 | 0 | 0 | 0 |
| | Y³⁺ | 0.2 | 0 | 0.5 | 1.7 | 1.2 | 1.5 | 1.6 | 1.7 |
| | La³⁺ | 0 | 1.2 | 0 | 0 | 0 | 0 | 0 | 0 |
| | Gd³⁺ | 1 | 0.5 | 0.4 | 0 | 0 | 0 | 0 | 0 |
| | Cu²⁺ | 12.5 | 11.7 | 12.3 | 13.5 | 12.8 | 14.4 | 12.7 | 10.5 |
| | Si⁴⁺ | 0 | 0 | 0 | 0 | 0 | 0 | 0 | 0 |
| | Zr⁴⁺ | 0 | 0 | 0 | 0 | 0 | 0 | 0 | 0 |
| | B³⁺ | 0 | 0 | 0 | 0 | 0 | 0 | 0 | 0 |
| | Sb³⁺ | 0 | 0 | 0 | 0 | 0 | 0 | 0 | 0 |
| | Sn²⁺ | 0 | 0 | 0 | 0 | 0 | 0 | 0 | 0 |
| | Ce⁴⁺ | 0 | 0 | 0 | 0 | 0 | 0 | 0 | 0 |
| | Total | 100 | 100 | 100 | 100 | 100 | 100 | 100 | 100 |
| Anions | O²⁻ | 95.2 | 93.4 | 92.5 | 96.4 | 94.4 | 92.4 | 92.5 | 93 |
| | F⁻ | 4.8 | 6.6 | 7.5 | 3.6 | 5.6 | 7.6 | 7.5 | 7 |
| | Cl⁻ | 0 | 0 | 0 | 0 | 0 | 0 | 0 | 0 |
| | Br⁻ | 0 | 0 | 0 | 0 | 0 | 0 | 0 | 0 |
| | I⁻ | 0 | 0 | 0 | 0 | 0 | 0 | 0 | 0 |
| | Total | 100 | 100 | 100 | 100 | 100 | 100 | 100 | 100 |

| | | | | | | | | |
|---|---|---|---|---|---|---|---|---|
| R²⁺ | 7.5 | 10.2 | 6.4 | 7 | 7.2 | 6 | 5.5 | 8 |
| Rn⁺ | 17.8 | 14.5 | 16.4 | 10.8 | 13.8 | 11.1 | 15.3 | 14.6 |
| Ln³⁺ | 1.2 | 1.7 | 0.9 | 1.7 | 1.2 | 1.5 | 1.6 | 1.7 |
| Al³⁺/Ln³⁺ | 5.167 | 1.588 | 2.778 | 1.941 | 2.083 | 1.067 | 1.5 | 2.118 |
| Li⁺/(Mg²⁺ + Al³⁺) | 1.935 | 2.042 | 2.689 | 1.241 | 5.12 | 2.707 | 2.638 | 1.802 |
| Cu²⁺/Al³⁺ | 2.016 | 4.333 | 4.92 | 4.091 | 5.12 | 9 | 5.292 | 2.917 |
| (Cu²⁺ + Mg²⁺)/ | 0.646 | 0.936 | 0.841 | 1.34 | 0.837 | 1.331 | 0.91 | 0.824 |
| (Li⁺ + Al³⁺) | | | | | | | | |
| Ln³⁺/R²⁺ | 0.16 | 0.167 | 0.141 | 0.243 | 0.167 | 0.25 | 0.291 | 0.213 |
| Ln³⁺/(Ba³⁺ + Al³⁺) | 0.112 | 0.347 | 0.17 | 0.347 | 0.124 | 0.294 | 0.356 | 0.239 |
| P⁵⁺/(Al³⁺ + Ln³⁺) | 7.405 | 13.45 | 18.09 | 12.74 | 16.89 | 21.1 | 15.63 | 11.62 |
| Cu²⁺/Ln³⁺ | 10.42 | 6.882 | 13.67 | 7.941 | 10.67 | 9.6 | 7.938 | 6.176 |
| P⁵⁺/R²⁺ | 7.307 | 5.804 | 9.609 | 9.1 | 8.681 | 10.9 | 11.36 | 7.7 |
| Ln³⁺/F⁻ | 0.25 | 0.258 | 0.12 | 0.472 | 0.214 | 0.197 | 0.213 | 0.243 |
| F⁻/Cu²⁺ | 0.384 | 0.564 | 0.61 | 0.267 | 0.438 | 0.528 | 0.591 | 0.667 |
| T_{g}(° C.) | 382 | 389 | 378 | 386 | 383 | 393 | 387 | 388 |
| α_{20-120° C.}(×10⁻⁷/K) | 85 | 86 | 85 | 90 | 89 | 86 | 87 | 88 |
| ρ(g/cm³) | 2.93 | 2.91 | 2.81 | 2.94 | 2.92 | 2.93 | 2.90 | 2.92 |
| Hᵥ(kgf/mm²) | 424 | 423 | 430 | 425 | 432 | 427 | 426 | 425 |
| E(×10⁷ Pa) | 7013 | 7154 | 7136 | 7025 | 7098 | 7013 | 7125 | 7018 |

The glass prepared from the examples described in Tables 1 to 3 was processed into glass sheets with a thickness of 0.2 mm. The spectral transmittance of the glass in each example was measured using the testing method described above, and the results are shown in Tables 4 to 6.

TABLE 4

| Example | 1# | 2# | 3# | 4# | 5# | 6# | 7# | 8# |
|---|---|---|---|---|---|---|---|---|
| τ₄₀₀(%) | 84.8 | 85.0 | 85.7 | 85.5 | 85.6 | 86.3 | 86.1 | 85.5 |
| τ₅₀₀(%) | 87.8 | 88.0 | 88.8 | 88.6 | 88.4 | 89.1 | 88.9 | 88.5 |
| τ₁₁₀₀(%) | 2.2 | 2.1 | 2.0 | 2.1 | 1.9 | 1.8 | 1.7 | 2.0 |
| λ₅₀(nm) | 628 | 627 | 626 | 627 | 625 | 622 | 624 | 628 |

TABLE 5

| Example | 9# | 10# | 11# | 12# | 13# | 14# | 15# | 16# |
|---|---|---|---|---|---|---|---|---|
| τ₄₀₀(%) | 86.7 | 86.5 | 86.2 | 87.0 | 86.3 | 85.2 | 85.7 | 86.0 |
| τ₅₀₀(%) | 89.5 | 89.3 | 89.0 | 90.2 | 89.1 | 88.3 | 88.6 | 88.3 |
| τ₁₁₀₀(%) | 1.5 | 1.3 | 1.6 | 1.2 | 1.7 | 2.1 | 1.8 | 2.1 |
| λ₅₀(nm) | 620 | 618 | 624 | 618 | 625 | 628 | 627 | 626 |

TABLE 6

| Example | 17# | 18# | 19# | 20# | 21# | 22# | 23# | 24# |
|---|---|---|---|---|---|---|---|---|
| τ₄₀₀(%) | 85.9 | 86.0 | 86.8 | 87.1 | 85.8 | 86.2 | 86.1 | 86.3 |
| τ₅₀₀(%) | 88.7 | 88.8 | 89.8 | 90.3 | 88.9 | 88.9 | 89.1 | 89.3 |
| τ₁₁₀₀(%) | 2.0 | 1.6 | 1.4 | 1.2 | 2.0 | 1.7 | 1.9 | 1.8 |
| λ₅₀(nm) | 625 | 625 | 619 | 620 | 625 | 623 | 624 | 625 |

The glass of the above-mentioned examples 1 # to 24 # is made into glass elements by methods well-known in the art, and examples thereof include thin plate-shaped glass elements or lenses used in near-infrared light absorption filters, which are suitable for color correction application in solid-state imaging elements and have various excellent properties of the above-mentioned glasses.

### <Example of Optical Filter>

The glass and/or glass elements of the above-mentioned examples 1 # to 24 # are made into optical filters by methods well-known in the art. The optical filters of the present application have color correction functions and also have various excellent properties of the above-mentioned glasses.

### <Example of Devices>

The glass and/or glass elements and/or optical filters of the present application can be used to manufacture devices such as portable communication devices (such as mobile phones), smart wearable devices, photographic devices, video devices, display devices, and monitoring devices by well-known methods. They can also be used in, for example, imaging devices, sensors, microscopes, medical technology, digital projection, optical communication technology/information transmission, or used in automotive camera devices and systems.

What is claimed is:

1. A glass, comprising following components in molar percentage of cations: P⁵⁺: 51-72%; Al³⁺: 0-10%; Cu²⁺: 5-25%; Rn⁺: 5-25%; R²⁺: 1-18%; Ln³⁺: 0-8%, wherein Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺; and
comprising following components of anions: O²⁻ and F⁻, wherein a total content of O²⁻ and F⁻ (O²⁻+F⁻) is more than 98%.

2. The glass according to claim 1, further comprising following components in molar percentage of cations: Zn²⁺: 0-10%; and/or Si⁴⁺: 0-5%; and/or B³⁺: 0-5%; and/or Zr⁴⁺: 0-5%; and/or Sb³⁺+Sn⁴⁺+Ce⁴⁺: 0-1%.

3. The glass according to claim 1, wherein the components in molar percentage of the glass meet one or more of following 11 conditions:
1) Al³⁺/Ln³⁺ is greater than 0.2;
2) Li⁺/(Mg²⁺+Al³⁺) is 0.4-10.0;
3) Cu²⁺/Al³⁺ is 1.0-15.0;
4) (Cu²⁺+Mg²⁺)/(Li⁺+Al³⁺) is 0.3-6.0;
5) Ln³⁺/R²⁺ is greater than 0.01;
6) Ln³⁺/(Ba²⁺+Al³⁺) is greater than 0.02;
7) P⁵⁺/(Al³⁺+Ln³⁺) is 5.0-50.0;
8) Cu²⁺/Ln³⁺ is greater than 2.0;
9) P⁵⁺/R²⁺ is 3.0-30.0;
10) Ln³⁺/F⁻ is greater than 0.01;
11) F⁻/Cu²⁺ is 0.05-2.0.

4. The glass according to claim 1, wherein the components in molar percentage of the glass meet one or more of following 11 conditions:
1) Al³⁺/Ln³⁺ is 0.5-15.0;
2) Li⁺/(Mg²⁺+Al³⁺) is 0.6-7.0;
3) Cu²⁺/Al³⁺ is 2.0-10.0;
4) (Cu²⁺+Mg²⁺)/(Li⁺+Al³⁺) is 0.5-5.0;
5) Ln³⁺/R²⁺ is 0.03-1.0;
6) Ln³⁺/(Ba²⁺+Al³⁺) is 0.05-1.0;
7) P⁵⁺/(Al³⁺+Ln³⁺) is 10.0-35.0;
8) Cu²⁺/Ln³⁺ is 5.0-30.0;
9) P⁵⁺/R²⁺ is 3.5-25.0;
10) Ln³⁺/F⁻ is 0.05-5.0;
11) F⁻/Cu²⁺ is 0.1-1.5.

5. The glass according to claim 1, wherein the components in molar percentage of the glass meet one or more of following 11 conditions:
1) Al³⁺/Ln³⁺ is 1.5-8.0;
2) Li⁺/(Mg²⁺+Al³⁺) is 1.2-3.0;
3) Cu²⁺/Al³⁺ is 4.0-7.0;
4) (Cu²⁺+Mg²⁺)/(Li⁺+Al³⁺) is 0.8-2.0;
5) Ln³⁺/R²⁺ is 0.07-0.5;
6) Ln³⁺/(Ba²⁺+Al³⁺) is 0.1-0.5;
7) P⁵⁺/(Al³⁺+Ln³⁺) is 15.0-25.0;
8) Cu²⁺/Ln³⁺ is 10.0-15.0;
9) P⁵⁺/R²⁺ is 5.0-10.0;
10) Ln³⁺/F is 0.1-1.0;
11) F⁻/Cu²⁺ is 0.3-0.8.

6. The glass according to claim 1, wherein the components in molar percentage of the glass further comprises: P⁵⁺: 56-68%; and/or Al³⁺: 0.5-8%; and/or Cu²⁺: 6-20%; and/or Rn⁺: 7-20%; and/or R²⁺: 3-16%; and/or Ln³⁺: 0.1-6%; and/or Zn²⁺: 0-5%; and/or Si⁴⁺: 0-2%; and/or B³⁺: 0-2%; and/or Zr⁴⁺: 0-2%; and/or Sb³⁺+Sn⁴⁺+Ce⁴⁺: 0-0.5%, wherein Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺.

7. The glass according to claim 1, wherein the components in molar percentage of the glass further comprises: P⁵⁺: 60-65%; and/or Al³⁺: 1-5%; and/or Cu²⁺: 8-15%; and/or Rn⁺: 10-17%; and/or R²⁺: 5-14%; and/or Ln³⁺: 0.5-4%; and/or Zn²⁺: 0-2%; and/or Si⁴⁺: 0-1%; and/or B³⁺: 0-1%; and/or Zr⁴⁺: 0-1%; and/or Sb³⁺+Sn⁴⁺+Ce⁴⁺: 0-0.1%, wherein Rn⁺ is one or more of Li⁺, Na⁺, and K⁺, R²⁺ is one or more of Mg²⁺, Ca²⁺, Sr²⁺, and Ba²⁺, and Ln³⁺ is one or more of La³⁺, Gd³⁺, and Y³⁺.

8. The glass according to claim 1, wherein the components in molar percentage of the glass further comprises: Li⁺: 5-25%; and/or Na⁺: 0-10%; and/or K⁺: 0-10%; and/or Mg²⁺: 0-15%; and/or Ca²⁺: 0-10%; and/or Sr²⁺: 0-10%; and/or Ba²⁺: 0-10%; and/or La³⁺: 0-5%; and/or Gd³⁺: 0-5%; and/or Y³⁺: 0-6%.

9. The glass according to claim 1, wherein the components in molar percentage of the glass further comprises: Li⁺: 10-16%; and/or Na⁺: 0-2%; and/or K⁺: 0-2%; and/or Mg²⁺: 2-8%; and/or Ca²⁺: 0-2%; and/or Sr²⁺: 0-2%; and/or Ba²⁺: 1-6%; and/or La³⁺: 0-2%; and/or Gd³⁺: 0-2%; and/or Y³⁺: 0.5-3%.

10. The glass according to claim 1, further comprising following components in molar percentage of anions: Cl⁻+Br⁻+I⁻: 0-2%.

11. The glass according to claim 1, wherein the components in molar percentage of the glass further comprises: O²⁻: 85-99.5%; and/or F⁻: 0.5-15%.

12. The glass according to claim 1, wherein the components in molar percentage of the glass further comprises: O²⁻: 91-98%; and/or F⁻: 2-9%.

13. The glass according to claim 1, wherein a transition temperature T_{g} of the glass is less than 410° C.; and/or a density ρ is less than 3.3 g/cm³; and/or a coefficient of thermal expansion α_{20-120° C.} is less than 110×10⁻⁷/K; and/or a hardness Hᵥ is more than 380 kgf/mm²; Young's modulus E is 5500×10⁷-8500×10⁷ Pa; and/or for glass with a thickness of less than 0.5 mm, in a spectral transmittance within a wavelength range of 500-700 nm, a wavelength λ₅₀ corresponding to the transmittance being 50% is less than 635 nm; and/or for the glass with a thickness of less than 0.5 mm, the transmittance τ₄₀₀ at 400 nm is more than 80.0%; and/or for the glass with a thickness of less than 0.5 mm, the transmittance τ₅₀₀ at 500 nm is more than 83.0%; and/or for the glass with a thickness of less than 0.5 mm, the transmittance τ₁₁₀₀ at 1100 nm is less than 10.0%.

14. The glass according to claim 1, wherein a transition temperature T_{g} of the glass is 370-390° C.; and/or a density ρ is less than 3.0 g/cm³; and/or a coefficient of thermal expansion α_{20-120° C.} is less than 95×10⁻⁷/K; and/or a hardness Hᵥ is more than 410 kgf/mm²; Young's modulus E is 6500×10⁷-7500×10⁷ Pa; and/or for glass with a thickness of less than 0.5 mm, in a spectral transmittance within a wavelength range of 500-700 nm, a wavelength λ₅₀ corresponding to the transmittance being 50% is 610-625 nm; and/or for the glass with a thickness of less than 0.5 mm, the transmittance τ₄₀₀ at 400 nm is more than 84.0%; and/or for the glass with a thickness of less than 0.5 mm, the transmittance τ₅₀₀ at 500 nm is more than 88.0%; and/or for the glass with a thickness of less than 0.5 mm, the transmittance τ₁₁₀₀ at 1100 nm is less than 3.0%.

15. A glass element, comprising the glass according to claim 1.

16. An optical filter, comprising the glass according to claim 1.

17. A device, comprising the glass according to claim 1.
